(19) United States
(12) Patent Application Publication
(10) Pub. No.: US 2002/0099832 A1
(43) Pub. Date: Jul. 25, 2002

(54) Method for accessing the internet

(76) Inventors: Tal Yaegerman, Herzliya (IL); Yehoshua Horesh, Kfar Bnei Zion (IL); Uri Alon, Moshav Hadar Am (IL); Yaron Reshef, Pardesiya (IL)

Correspondence Address: BIRCH STEWART KOLASCH & BIRCH, PO BOX 747, FALLS CHURCH, VA, 22040-0747, US

(21) Appl. No.: 09/765,673

(22) Filed: Jan. 22, 2001

(51) Int. Cl. G06F 15/16

(52) U.S. Cl. 709/228; 709/203; 709/217

(57) ABSTRACT

The present invention concerns a method for accessing a computerized network suck as the Internet, wherein the user can choose whether to browse the Internet under his actual user name or under a user alias.

### FIELD OF THE INVENTION

This invention relates to a method for accessing the Internet, and more particularly to a method for accessing the Internet anonymously.

### BACKGROUND OF THE INVENTION

One of the fastest growing fields in the world is commercialization of the Internet. The use of various internet applications such as internet navigation through the World Wide Web (WWW), online chat rooms, video conferencing and electronic mail, is widespread and popular as it allows internet users to view and distribute information and data for the purpose of business transactions, communication, research, entertainment and the like.

During navigation, Internet users face several commonly encountered problems, two notorious problems being security and privacy issues. When users browse the Internet, they enter various web sites on the WWW and perform various transactions. However, since the browsing and transaction activity of the user may be tacked and monitored, the privacy and security of the user may easily be violated.

Various encryption techniques have been developed in order to solve a problem of security, for example for the protection of personal and credit card information sent over the Internet.

In addition to security, Internet users often seek anonymity while browsing web sites due to the fact that they do not wish others to know they visited the sites (such as sex sites). However, obtaining true anonymity is difficult to achieve and maintain on the Internet. An Internet Service Provider (ISP) allowing the user an access to the Internet, and Internet Content Provider (ICP) maintaining the web site currently visited by the Internet user, both have the capability of tracking and monitoring the user's activity on the Internet. For example, both the ISP and ICP can determine the Internet Protocol (IP) address of the user and the Universal Resource Locator (URL) addresses of web sites visited by the Internet user before the user arrived at the given web site. Additionally, a computer hacker also can obtain information concerning the Internet user without prior authorization or knowledge of the Internet user.

One known method of collecting Internet user information by ICP is to implant temporary Internet files into a hard drive of the computer of the internet user, for example, files referred to as “cookies”. A “cookie” is a set of data, which the ICP downloads automatically through me Internet when the user visits the web sites first time. Among other things, cookies are updated with each return visit, and may inform the ICP of the web site visited, for example, a username, password, the items purchased via e-commerce, the chat rooms and web sites visited. This information is retrieved automatically without informing or asking permissions from the user.

Many techniques are known in the art for providing anonymity for Internet users. For example, for anonymous browsing over the Internet the user may utilize the techniques provided by the Anonymizer.com Inc. (http://www.anonymizer.com), the Lucent Personalized Browser described in U.S. Pat. No. 5,961,593 and/or an anonymous web site information communication method described in European Patent Application No. 1,017,205.

There are also techniques which filters both inbound and outbound communications between the user's computer and the outside world and remove the data (e.g., cookies) that already entered into the computer. These techniques, for example, include the “Anonymizer Window Washer” that may automatically run in the computer and remove cookies and any tracks that the user wants to erase. Another example is “McAfee Firewall Software” that protects both dial-up or direct Internet connections from Internet hazards such as hacker trying to steal information or a virus program taking control of the user's computer.

European Patent Application No. 1,033,854 describers a system and method enabling a user using an alias (in lieu of a actual identity name of the user) to access anonymously to the Internet. The user may browse and visit web sites of various merchandise, services, funds, etc. offered by Internet contest providers and pay for the merchandise made available through those sites anonymously.

### SUMMARY OF THE INVENTION

There is, accordingly, a need in the art to provide a simple, user friendly, technique, which enables a user to choose, at the step of access to the Internet, whether to utilize a real name or alias for browsing the Internet. There is further a need for an Internet Server Provider to be able to offer the clients of Internet an additional access and services option of receiving a service which allows the client (user) to select in each Internet session, whether he/she will browse the Internet under his/her real name or under an alias.

The present invention is based on the realization that many users would like to access the Internet by either of the two following modes: “an actual user name mode” wherein the user accesses the Internet utilizing his actual user name and “a user alias mode” wherein the user accesses the Internet anonymously, in a manner which cannot be traced or monitored. Furthermore, the present invention is based on the realization that the user would like to select sometimes the “actual user name” and sometimes the “user alias mode” and that said selection should be in a user friendly manner.

Accessing the Internet with the actual user name is required in many cases, for example where financial transactions are to take place, during various modes of e-commerce. In addition, many times web sites, which require registration, such as for example online scientific journals, allow registration only when actual user names are used.

The present invention further concerns services which the ISP provides to its users, wherein in each session of communication to the Internet, the user can decide, in a user friendly manner, whether the access is through his actual user name, or his through his user alias name in an anonymous mode.

Thus by one aspect the present invention provides a method for enabling a user communication device to access a computerized network through a provider of a computerized network connecting service, the method comprising:

(i) displaying a graphical user interface window on a display of the user communication device, the interface window, comprising at least an input name box for the entry of identification user name, and an input password box for the entry of a user password;

(ii) entering in said input password box a user password;

(iii) entering in said input name box either an actual user name or a user alias;

(iv) connecting to the computerized network through the provider;

thereby enabling the user communication device to browse the computerized network either under the actual user name or anonymously under the user alias.

By a preferred embodiment the “computerized network” is the Internet and “the provider of a computerized network connecting service” is an Internet Service Provider (ISP). According to a preferred embodiment the “user communication device” is a user computer having a browser software for navigation through the Internet. In that case the “display” is the user computer screen.

The invention further concerns a program storage device readable by a user communication device, tangibly embodying a program of instructions executable by the device to perform method steps for enabling said user communication device to access a computerized network through a provider of a computerized network connecting service, the method comprising.

(i) displaying a graphical user interface window on a display of the user communication device, the interface window comprising at least an input name box for tile entry of identification user name, and an input password box for the entry of a user password;

(ii) entering in said input password box a user password;

(iii) entering in said input name box either an actual user name or a user alias;

(iv) connecting to the computerized network through the provider thereby enabling the user communication device to browse the computerized network either under the actual user name or anonymously under the user alias.

The invention further concerns a computer program product comprising a computer useable medium having computer readable program code embodied therein for enabling a user communication device to access a computerized network through a provider of a computerized network connecting service, the computer program product comprising:

(i) computer readable program code for causing the computer to display a graphical user interface window on a display of the user communication device, the interface window comprising at least an input name box for the entry of identification user name, and an input password box for the entry of a user password;

(ii) computer readable program code for causing the computer to entering in said input password box a user password;

(iii) computer readable program code for causing the computer to entering in said input name box either an actual user name or a user alias;

(iv) computer readable program code for causing the computer to connect to the computerized network through the provider;

thereby enabling the user communication device to browse the computerized network either under the actual user name or anonymously under the user alias.

By a preferred embodiment of the invention, the graphical user interface window comprises three input boxes: an input password box for entering of the user's password and two separate input name boxes: one for entering the actual user name and one for entering the user alias. Each of the two input name boxes is associated with a separate network connection module. Such an interface allows a user friendly selection between the actual user name mode and the user alias mode. If the user enters in the input name box of the actual user name his real name and then selects the associates connection module (for example as an option “dial” or “connect”) the user browses the Internet under his actual name. If the user enters into the input name box of the alias user the alias name and then chooses the associated connection module, he browses the Internet under an anonymous mode.

According to another aspect of the invention the present invention provides a method for enabling a user communication device selective access to computerized network through a provider of a computerized network connecting service, the method comprising;

A method for enabling a user communication device selective access to computerized network through a provider of a computerized network connecting service, the method comprising:

(v) receiving user identification data from user communication device;

(vi) proofing the user identification data;

(vii) checking whether said identification data represent an actual user name or a user alias;

(viii) providing the user communication device with anonymous browsing if said user alias is used or providing the user communication device named browsing of the computerized network if said actual user name is used.

According to a preferred embodiment the user identification data include the user identification name and password.

The invention further provides a program storage device readable by machine, tangibly embodying a program of instructions executable by the machine to perform method steps for enabling a user communication device selective access to computerized network through a provider of a computerized network connecting service, the method comprising:

(i) receiving user identification data from user communication device;

(ii) proofing the user identification data;

(iii) checking whether said identification data represent the actual user name or the user alias;

(iv) providing the user communication device with anonymous browsing if said user alias is used or providing the user communication device named browsing of the computerized network if said actual user name is used.

The invention further concerns a computer program product comprising a computer useable medium having computer readable program code embodied therein for enabling a user communication device selective access to computerized network through a provider of a computerized network connecting service, the computer program product comprising:

(i) computer readable program code for causing the computer to receive user identification data from user communication device;

(ii) computer readable program code for causing the computer to proofing the user identification data;

(iii) computer readable program code for causing the computer to checking whether said identification data represent the actual user name or the user alias;

(iv) computer readable program code for causing the computer to providing the user communication device with anonymous browsing if alias user name was entered or named browsing of the computerized network if an actual user name was entered.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a function block diagram showing a connectivity architecture of the computer network according to a preferred embodiment of the present invention;

FIG. 2 illustrates a sample of a graphical user interface window which can be utilized to implement identification of the user at his access the Internet according to a preferred embodiment of the present invention;

FIG. 3 shows another embodiment of a graphical user interface window with two input name boxes: one for entering the actual user name and one for entering the user alias; and

FIG. 4 is a flow diagram illustrating the process of accessing the Internet according to a preferred embodiment of the present invention.

### DETAILED DESCRIPTION OF THE INVENTION

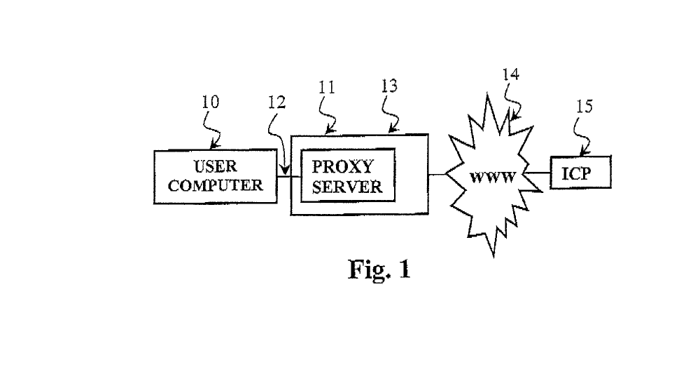

Turning now to FIG. 1, there is shown a generalized schematic illustration of a computer network architecture according to a preferred embodiment of the present invention. A user computer 10 executing an Internet browser application (not shown) is connected to a proxy server 11 through a public wireline switched telephone network (PSTN) 12. The proxy server 11 is in turn connected to of an Internet Service Provider (ISP) 13 to receive access to the Internet, It should be appreciated that the proxy server 11 may itself be an ISP. The ISP 13 provides the user computer 10 with access to the Internet for browsing the World Wide Web (WWW) 14. Through the WWW 14 a data communication link is established with a particular web site (not shown) operated by an Internet Content Provider (ICP) 15,

It should be appreciated that the present invention is not intended to be restricted to any particular user computer/proxy server connection. Hence, user computer 10 may be connected to the proxy server 11 through a local area network (LAN ) instead of the connection through the telephone network 14.

It should be appreciated that any number of the user computers 10, Internet Service Providers 13 and the Content Providers 15 may be linked via the WWW, although for simplicity of illustration, only one of each such stations is explicitly shown.

In accordance with one embodiment of the invention the user computer 10 is provided with software (not shown) that enables the user to perform a named or anonymous access to the Internet. In another embodiment, the access is established by utilizing the operating system (not shown) hosted by the proxy server 11 to communicate with the user computer 10.

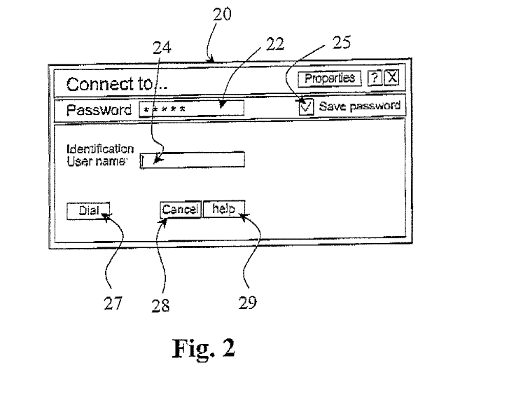

Referring now to FIG. 2, in accordance with an embodiment of the present invention, after the initialization, the user is provided with a graphical user interface window 20 on a display such as a screen (not shown) of the user computer (10 in FIG. 1). The graphical user interface window 20 displays a request to enter user identification data that is necessary for receiving access to the Internet. This data is entered in suitable input boxes, for example an input password box for entering user password and input identification box for entering user identification name. According to the preferred embodiment of the present invention, the user indication data requested in the interface window 20 includes a user password 22 and identification name 24 supplied by the user. According to the invention, the identification name 24 may be either an actual user name that was assigned to the user at his/her registration with the ISP (13 in FIG. 1) or a user alias. Such implementation provides the user with a possibility to choose whether he/she wishes a named access to the Internet or an anonymous access.

According to the invention, the user alias may have different status. According to one embodiment, the user alias may be a pre-agreed-upon alias created when the user first established a registration with the ISP. According to another embodiment the alias may be created by the user dynamically on the fly. Such dynamic creation of the alias may be the same or different for each Internet session.

Each time tie user establishes a connection with the ISP by utilizing an alias (i.e. not an actual identification name), the ISP guarantees the user confidentiality of user's actual identification and provides the user with possibilities to browse the Internet anonymously.

It should be appreciated that the present invention and the concept of providing a user with a possibility to access the Internet either anonymously or by using an actual identification is not bound to any particular graphical design of the interface window displaying a request to enter user data information. Hence, according to the illustrative embodiment shown in FIG. 2, interface window 20 may further include such elements as a “Save Password” box 25, along with “Properties”, “Dial”, “Cancel” and “Help” buttons 26, 27, 28 and 29, respectively. The purpose of these elements is known per se, and thereby will not be expounded hereinbelow.

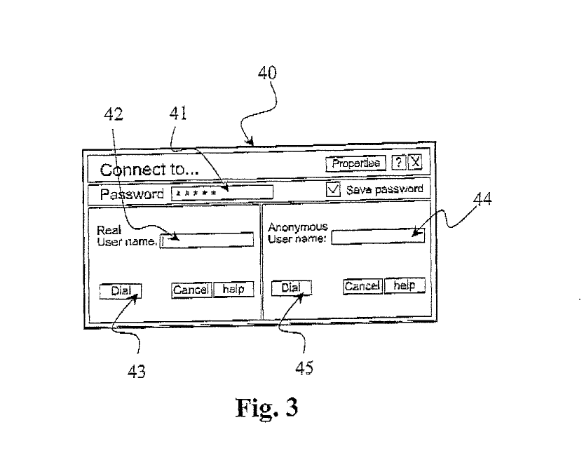

Reference is now made to FIG. 3, which shows a graphical user interface window 40 in accordance with a preferred embodiment of the invention, present on a display of the user computer. The graphical user interface window 40 displays a single request for a user password in an input password box 41.

Then the user can choose between two options: whether to browse with his actual user name or with is alias name. If he chooses the actual user name he enters his real name in the input name box 42. In that case connection is made by selecting “dial” 43.

If the user wishes to browse the Internet anonymously, he enters his alias user name in input name box 44 and selects connection by “dial” 45. The remaining options are as defined in FIG. 2. The above graphical user interface allows the user to choose easily between the two modes of access to the Internet.

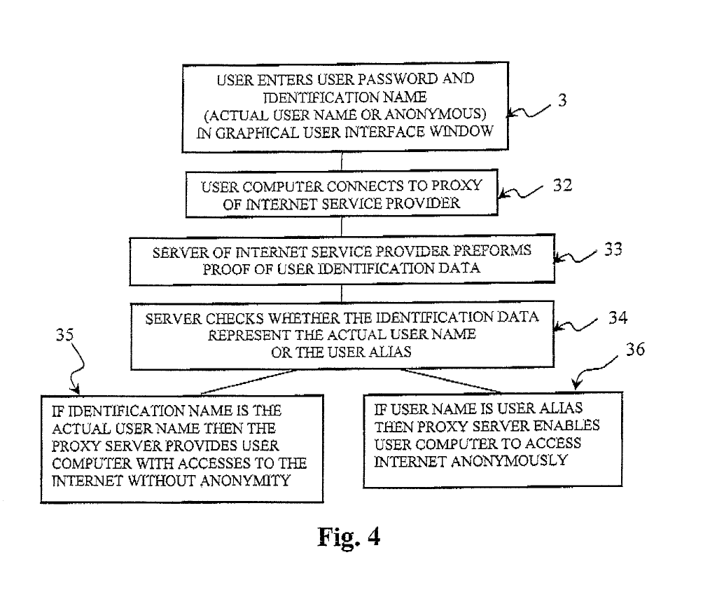

Referring to FIG. 1, FIG. 2 and FIG. 3 and FIG. 4 together, in order to access the Internet, the user enters 31 the user password 22 and the identification name 24 (either an actual user name or anonymous) in the graphical user interface window 20 or alternatively enters password 41 and either real name 42 or alias user name 44 in window 40 (FIG. 3). After connecting 32 the user computer 10 to the proxy server 11 of the ISP 13, the server 11 performs 33 a proof of identification data. Then, the server 11 checks whether the identification data represent the actual user name or the user alias.

Thus, if the identification name 24 is the actual user name, then the proxy server 11 provides the user computer 10 with accesses 34 to the Internet without anonymity. In this case the user may browse the Internet, visit web sites offered by various ICPs and pay for products and services without anonymity.

Alternatively, if the user name 24 is the user alias, then the proxy server 11 enables the user computer to access 35 the Internet anonymously. By the option specified in FIG. 3, since each of dials 42 or 45 is associated with a different mode of browsing, the choice of the dials determines which mode to user browse.

In order to perform anonymous electronic commerce trough the Internet,the user may utilize techniques described in U.S. Pat. No. 5,961,593, European Patent Application No. 1,017,205 or European Patent Application No. 1,033,854 (hereby incorporated by reference). For example, the user may establish a line of credit or deposit funds with the ISP. In this case, the ISP may make payments to the ICP and accept merchandise from the ICP, on behalf of the user.

While the present invention has been focused primarily on Internet based application where the user is running a browser hosted by a user's computer, those versed in the in the art will readily appreciate that the invention is, by no means, bound by this particular embodiment. Thus, by way of non-limiting example, in accordance with a modified embodiment the invention is applicable to Intranet or other networks that employ or could employ a corresponding communication protocol and/or a graphical user interface window.

Further, a security of the user may be increased by performing a known per se encryption process for communicating between the computer (10 in FIG. 1) and proxy server 11. Yet further a privacy of the user may be increased by plugging-in a firewall software in the computer (10 in FIG. 1), for example the aforementioned McAfee Firewall software that protects both dial-up or direct Internet connections.

1. A method for enabling a user communication device to access a computerized network, through a provider of a computerized network connecting service, the method comprising:
(i) displaying a graphical user interface window on a display of the user communication device, the interface window comprising at least an input name box for the entry of identification user name, and an input password box for the entry of a user password;
(ii) entering in said input password box a user password;
(iii) entering in said input name box either an actual user name or a user alias;
(iv) connecting to the computerized network through the provider
thereby enabling the user communication device to browse the computerized network either under the actual user name or anonymously under the user alias.

2. The method of claim 1 wherein the computerized network is the Internet.

3. The method of claim 1 wherein the provider is an Internet Service Provider (ISP).

4. The method of claim 2 wherein the user communication device is a user computer having a browser software for navigation through the Internet

5. The method of claim 1 wherein the user alias is a pre-agreed-upon alias.

6. The method of claim 1 wherein the user creates the alias dynamically on the fly.

7. A method of claim 1, wherein the graphical user interface window comprises an input password box for the entry of a user password and comprises two input name boxes: one for the entry of an actual user name and one for the entry of the user alias.

8. A method according to claim 7, wherein the graphical user interface comprises two connection modules, each connection module associated with one of the input name boxes.

9. A method for enabling a user communication device selective access to computerized network trough a provider of a computerized network connecting service, the method comprising:
(i) receiving user identification data from user communication device;
(ii) proofing the user identification data;
(iii) checking whether said identification data represent an actual user name or a user alias;
(iv) providing the user communication device with anonymous browsing if said user alias is used or providing the user communication device named browsing of the computerized network if said actual user name is used.

10. The method of claim 9, wherein the user identification data include the user identification name and password.

11. The method of claim 9, wherein the computerized network is the Internet.

12. The method of claim 9, wherein the provider is an Internet Service Provider (ISP).

13. The method of claim 11, wherein the user communication device is a user computer having a browser software for navigation through the Internet.

14. The method of claim 9, wherein the user alias is a pre-agreed-upon alias.

15. The method of claim 7 wherein the user creates the alias dynamically on the fly.

16. A program storage device readable by a user communication device, tangibly embodying a program of instructions executable by the device to perform method steps for enabling said user communication device to access a computerized network through a provider of a computerized network connecting service, the method comprising:
(i) displaying a graphical user interface window on a display of the user communication device, the interface window comprising at least an input name box for the entry of identification user name, and an input password box for the entry of a user password;
(v) entering in said input password box a user password;
(vi) entering in said input name box either an actual user name or a user alias;
(vii) connecting to the computerized network through the provider thereby enabling the user communication device to browse the computerized network either under the actual user name or anonymously under the user alias.

17. A computer program product comprising a computer useable medium having computer readable program code embodied therein for enabling a user communication device to access a computerized network through a provider of a computerized network connecting service, the computer program product comprising:
(i) computer readable program code for causing the computer to display a graphical user interface window on a display of the user communication device, the interface window comprising at least an input name box for the entry of identification user name, and an input password box for the entry of a user password;
(ii) computer readable program code for causing the computer to entering in said input password box a user password;
(iii) computer readable program code for causing the computer to entering in said input name box either an actual user name or a user alias;
(iv) computer readable program code for causing the computer to connect to the computerized network through the provider
thereby enabling the user communication device to browse the computerized network either under the actual user name or anonymously under the user alias.

18. The computer program product of claim 17 for use in a user communication device.

19. A program storage device readable by machine, tangibly embodying a program of instructions executable by the machine to perform method steps for enabling a user communication device selective access to computerized network through a provider of a computerized network connecting service, the method comprising:
(i) receiving user identification data from user communication device;
(ii) proofing the user identification data;
(iii) checking whether said identification data represent the actual user name or the user alias;
(iv) providing the user communication device with anonymous browsing if said user alias is used or providing the user communication device named browsing of the computerized network if said actual user name is used.

20. A computer program product comprising a computer useable medium having computer readable program code embodied therein for enabling a user communication device selective access to computerized network through a provider of a computerized network connecting service, the computer program product comprising:
(i) computer readable program code for causing the computer to receive user identification data from user communication device;
(ii) computer readable program code for causing the computer to proofing the user identification data;
(iii) computer readable program code for causing the computer to checking whether said identification data represent the actual user name or the user alias;
(iv) computer readable program code for causing the computer to providing the user communication device with anonymous browsing if alias user name was entered or named browsing of the computerized network if an actual user name was entered.

21. The computer program product of claim 20 for use in a proxy of said provider.
